(19) United States
(12) Patent Application Publication
(10) Pub. No.: US 2012/0306110 A1
(43) Pub. Date: Dec. 6, 2012

(54) LOCKING APPARATUS AND CONTROL METHOD OF LOCKING APPARATUS

(75) Inventor: Harumichi Tokuyama, Odawara-shi (JP)

(73) Assignee: TOSHIBA KIKAI KABUSHIKI KAISHA, CHIYODA-KU (JP)

(21) Appl. No.: 13/482,971

(22) Filed: May 29, 2012

(30) Foreign Application Priority Data
May 30, 2011 (JP) 2011-120857

(51) Int. Cl. B29C 45/76

(52) U.S. Cl. 264/40.1; 425/139

(57) ABSTRACT

A locking apparatus includes a stationary platen on which a stationary die is mounted, a movable platen on which a movable die is mounted, a locking drive mechanism that advances or retreats the movable platen, an ejecting member held in the movable platen to remove a molded product from the movable die, a protruding drive mechanism that pushes out the ejecting member from the movable die, and an error detection unit that detects extraneous material based on a state change of the ejecting member or the protruding drive mechanism during a closing operation.

### CROSS-REFERENCE TO RELATED APPLICATIONS

This application is based upon and claims the benefit of priority from prior Japanese Patent Application No. 2011-120857, filed May 30, 2011, the entire contents of which are incorporated herein by reference.

### BACKGROUND OF THE INVENTION

1. Field of the Invention

The present invention relates to a locking apparatus including an ejecting member and a control method of the locking apparatus.

2. Description of the Related Art

In a molding machine that injects a molten material of resin or metal into a die for molding, a molded product may remain on a mating surface of the die due to a removing error or drop error. If a locking operation is performed in such a state, a locking force is applied while a molded product is remaining between dies, which could damage the die or the molding machine. Thus, there is a molding machine that detects an error when a molded product remains by monitoring torque of a locking motor that moves a movable platen and comparing the torque with the torque during normal operation.

Jpn. Pat. Appln. KOKAI Publication No. 2002-172670 discloses an injection molding machine in which a monitoring section is provided in a closing process. The injection molding machine detects a physical quantity involved in the closing operation and detects an error when the deviation of the detected value of the physical quantity from a preset value becomes equal to a preset threshold or more.

Jpn. Pat. Appln. KOKAI Publication No. 2004-330527 also discloses an injection molding machine in which a monitoring section is provided in a closing process. The injection molding machine detects an error when torque or the speed of a servomotor that performs a closing operation exceeds a threshold.

Jpn. Pat. Appln. KOKAI Publication No. 2004-142211 discloses an injection molding machine that adopts a nominal pattern of the relationship between the position of a movable platen and a locking force when locking is carried out in a good condition. The injection molding machine sets a monitoring section based on the nominal pattern and alerts that the locking force exceeds an allowable limit in the monitoring section.

Jpn. Pat. Appln. KOKAI Publication No. 2006-334820 discloses a molding machine that stops driving of a locking motor when torque of the locking motor exceeds a limiting value in a monitoring section of the locking operation.

Jpn. Pat. Appln. KOKAI Publication No. 2009-279891 discloses an injection molding machine that determines the load of a movable portion by detecting a motor current, estimating the load from a disturbance load observer, or measuring the load directly by using a strain sensor. The injection molding machine handles one past load or a plurality of past loads of the movable portion as the nominal load for error detection for the determined load. If the deviation of the nominal load for error detection from the current load exceeds an allowable range, the servomotor driving the movable portion is stopped.

Jpn. Pat. Appln. KOKAI Publication No. 9-207182 discloses a die protective apparatus that detects that a movable mold and a movable platen move relatively when extraneous material exists between the movable mold and a stationary mold and stops a mold opening/closing drive unit.

According to many methods of detecting a molded product remaining between a movable die and a stationary die as extraneous material, as described above, an error is detected by monitoring torque of a locking servomotor that moves a movable platen and comparing the torque with the torque during normal operation. In this case, the die and the movable platen are heavy and torque needed to move the movable platen correspondingly becomes large. The needed torque varies to some extent depending on a greasing state. Thus, the threshold to determine whether an error occurs by comparing with a value during normal operation becomes a value with a margin that takes the above variation into consideration.

Since a molded product is light and soft when compared with the die or the movable platen, the amount of change in torque of the locking servomotor is very small, even if the dies or movable platen sandwich the molded product. Thus, when motor torque changes by exceeding the threshold, the molded product may already be terribly crushed and damages the dies.

### BRIEF SUMMARY OF THE INVENTION

An object of the present invention is to provide a locking apparatus and a control method of the locking apparatus, which are capable of improving the precision for detecting an error.

A locking apparatus according to one embodiment of the present invention to achieve the object includes a stationary platen on which a stationary die is mounted, a movable platen on which a movable die is mounted, a locking drive mechanism that advances or retreats the movable platen, an ejecting member held in the movable platen to remove a molded product from the movable die, a protruding drive mechanism that pushes out the ejecting member, and an error detection unit that detects extraneous material based on a state change of the ejecting member or the protruding drive mechanism during a closing operation.

A control method of a locking apparatus according to an aspect of the present invention to achieve the object includes detecting extraneous material based on a state change of an ejecting member or an protruding drive mechanism at least during a closing operation, wherein the locking apparatus includes a stationary platen on which a stationary die is mounted, a movable platen on which a movable die is mounted, a locking drive mechanism that advances or retreats the movable platen, the ejecting member held in the movable platen to remove a molded product from the movable die, and the protruding drive mechanism that pushes out the ejecting member.

According to the present invention, the precision for detecting an error is improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of an injection molding machine which including a locking apparatus according to an embodiment of the present invention;

FIG. 2 is a side view of a locking apparatus shown in FIG. 1;

FIG. 3 is a block diagram schematically showing the configuration of a portion of a controller shown in FIG. 1;

FIG. 4 is a graph showing an example of the relationship between the die position and the ejector pin position of the locking apparatus shown in FIG. 1; and

FIG. 5 is a graph showing another example of the relationship between the die position and the ejector pin position of the locking apparatus shown in FIG. 1.

### DETAILED DESCRIPTION OF THE INVENTION

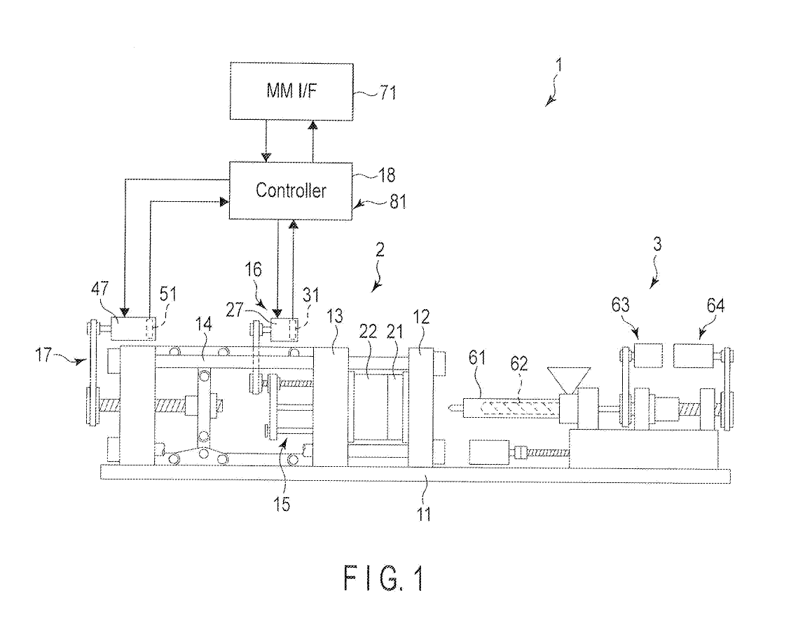

FIGS. 1 to 5 show an injection molding machine 1 which including a locking apparatus 2 according to an embodiment of the present invention. The injection molding machine 1 is an example of a “molding machine”. As shown in FIG. 1, the injection molding machine 1 includes the locking apparatus 2 and an injection apparatus 3. The locking apparatus 2 includes a frame 11, a stationary platen 12, a movable platen 13, a tie bar 14, an ejecting member 15, a protruding drive mechanism 16, a locking drive mechanism 17, and a controller 18.

The frame 11 forms the foundation of the injection molding machine 1. A linear guide (not shown) is provided on the frame 11. The stationary platen 12 is fixed onto the frame 11. A stationary die 21 is mounted on the stationary platen 12. The number of the tie bars 14 provided is, for example, four. An end of the tie bar 14 as a first end is fixed to the stationary platen 12. The tie bar 14 extends to the locking drive mechanism 17 from the stationary platen 12 by passing through the movable platen 13.

The movable platen 13 is placed on the linear guide of the frame 11 and opposed to the stationary platen 12. The movable platen 13 is movable in the direction approaching the stationary platen 12 and also in the direction moving away from the stationary platen 12 by being guided by the tie bar 14 or the linear guide. A movable die 22 opposite to the stationary die 21 is mounted on the movable platen 13. A cavity corresponding to a product shape is formed between the movable die 22 and the stationary die 21 after the movable die 22 and the stationary die 21 being fitted.

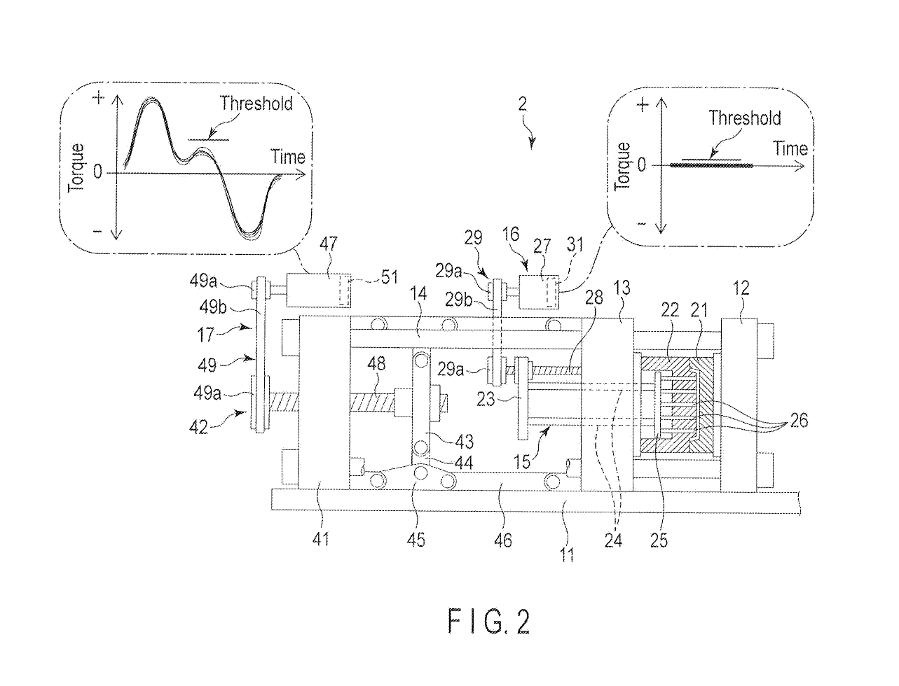

As shown in FIG. 2, the ejecting member 15 is held by the movable platen 13. The ejecting member 15 is pushed out as if to protrude from the die surface of the movable die 22 when a molded product to be a product is ejected to remove the molded product from the movable die 22.

An example of the ejecting member 15 includes a pushing plate 23, a pushing rod 24, a pushing platen 25, and an ejector pin 26. The pushing plate 23 is provided on the opposite side of the stationary platen 12 with respect to the movable platen 13. The pushing rod 24 is supported by the pushing plate 23 and passed through the movable platen 13 to extend into the movable die 22.

The pushing platen 25 is mounted on the tip of the pushing rod 24 and supported by an inner side of the movable die 22. The ejector pin 26 is supported by the pushing platen 25 to pass through the movable die 22. when the pushing platen 25 is driven while the stationary die 21 and the movable die 22 are separated, the ejector pin 26 is exposed between the movable die 22 and the stationary die 21. The pushing plate 23, the pushing rod 24, the pushing platen 25, and the ejector pin 26 are mutually integrated and can move toward or away from the movable platen 13 so as to move in the left and right direction in FIG. 2. The configuration of the ejecting member 15 is not limited to the above configuration and the ejecting member 15 may be configured by, for example, the pushing plate 23 and the ejector pin 26 directly fixed to the pushing plate 23.

The protruding drive mechanism 16 is mounted on the surface on the opposite side of the movable die mounting surface of the movable platen 13. The protruding drive mechanism 16 pushes out the ejecting member 15 when, for example, a molded product is ejected to remove the molded product from the movable die 22. In this application, “pushing” means causing the ejecting member 15 to protrude from the die surface of the movable die 22.

An example of the protruding drive mechanism 16 includes a push-out servomotor 27, a ball screw 28, and a transfer mechanism 29. The ball screw 28 is an example of a motion direction conversion mechanism that converts a rotational motion into a linear motion and is connected to the pushing plate 23. When the ball screw 28 is rotated, the ejecting member 15 advances or retreats.

The transfer mechanism 29 is configured by, for example, a rotator 29a, a pulley in the present embodiment, a linear body 29b placed on the rotator 29a, a timing belt in the present embodiment, and the like. The transfer mechanism 29 transfers the rotation of the push-out servomotor 27 to the ball screw 28. When the push-out servomotor 27 is rotated, the ejecting member 15 advances or retreats. The configuration of the protruding drive mechanism 16 is not limited to the above configuration and other configurations may be adopted.

As shown in FIG. 1, a first detector 31 is provided in the protruding drive mechanism 16. The first detector 31 detects information about the state of the ejecting member 15 or the protruding drive mechanism 16. “Information about the state of the ejecting member 15 or the protruding drive mechanism 16” is, for example, information about the position of the ejecting member 15, the position of the protruding drive mechanism 16, the speed of the protruding drive mechanism 16, the acceleration of the protruding drive mechanism 16, or torque of the protruding drive mechanism 16.

In the present embodiment, the first detector 31 is provided in, for example, the push-out servomotor 27 to detect torque (load torque) of the push-out servomotor 27. The first detector 31 may also detect information about, for example, the rotation of the push-out servomotor 27.

The first detector 31 sends the detected information to the controller 18. “Information about the state of the ejecting member 15 or the protruding drive mechanism 16” is not limited to directly measured position information of the ejecting member 15 and the like and may be information about the state of the ejecting member 15 or the protruding drive mechanism 16, the position of the ejecting member 15, the position of the protruding drive mechanism 16, the speed of the protruding drive mechanism 16, the acceleration of the protruding drive mechanism 16, or torque of the protruding drive mechanism 16 that can be determined by the controller 18 by mathematical calculation based on the information.

The first detector 31 is not limited to the one provided in the push-out servomotor 27 and may be one provided in other portions such as the ejecting member 15 or the protruding drive mechanism 16. The first detector 31 may also be other than the one described above.

As shown in FIG. 2, the locking drive mechanism 17 is provided on the opposite side of the stationary platen 12 with respect to the movable platen 13. An example of the locking drive mechanism 17 is a toggle mechanism. However, the configuration of the locking drive mechanism 17 is not limited to the toggle mechanism and may be a configuration using, for example, a hydraulic cylinder and a tie bar or other configurations. The locking drive mechanism 17 in the present embodiment includes, for example, a toggle support 41, a toggle mechanism drive unit 42, a cross head 43, a first toggle lever 44, a second toggle lever 45, and a toggle lever 46

The toggle support 41 is a support portion of the toggle locking apparatus and is supported on the frame 11 as a pressure receiving platen. The other end of the tie bar 14 as a second end is fixed to the toggle support 41. The toggle mechanism drive unit 42 is provided in the toggle support 41 and includes, for example, a locking servomotor 47, a ball screw 48, and a transfer mechanism 49.

The cross head 43 is mounted on the tip of the ball screw 48. The ball screw 48 is an example of the motion direction conversion mechanism that converts a rotational motion into a linear motion. When the ball screw 48 is rotated, the cross head 43 moves toward or away from the movable platen 13 so as to move in the left and right direction in FIG. 1.

The transfer mechanism 49 is configured by, for example, a body of rotation 49a, a pulley in the present embodiment, a linear body 49b placed on the body of rotation 49a, a timing belt in the present embodiment, and the like. The transfer mechanism 49 transfers the rotation of the locking servomotor 47 to the ball screw 48. When the locking servomotor 47 is rotated, the cross head 43 advances or retreats.

The first toggle lever 44 is connected to the cross head 43. The second toggle lever 45 is provided between the toggle support 41 and the first toggle lever 44. The toggle arm 46 is provided between the second toggle lever 45 and the movable platen 13. The toggle support 41 and the second toggle lever 45, the first toggle lever 44 and the second toggle lever 45, the second toggle lever 45 and the toggle arm 46, the cross head 43 and the first toggle lever 44, and the toggle arm 46 and the movable platen 13 are swingably linked.

When the cross head 43 is advanced or retreated, the toggle mechanism is actuated. That is, when the cross head 43 advances, that is, moves in the right direction in FIG. 2, the movable platen 13 is moved toward the stationary platen 12 to close the die. Moreover, a locking force multiplied by a toggle multiplying factor is added to the movable platen 13 to close the movable die 22 and the stationary die 21. The configurations of the toggle mechanism and the toggle mechanism drive unit are not limited to the above ones and may be other configurations.

As shown in FIG. 1, a second detector 51 is provided in the locking drive mechanism 17. The second detector 51 detects information about the locking state. “Information about the locking state” includes informations related to the position of the movable platen 13 or the locking drive mechanism 17, the speed of the movable platen 13 or the locking drive mechanism 17, the acceleration of the movable platen 13 or the locking drive mechanism 17, the torque of the locking drive mechanism 17, and so on.

In the present embodiment, the second detector 51 is provided in, for example, the locking servomotor 47 to detect torque, load torque in this case, of the locking servomotor 47. The second detector 51 may also detect information about, for example, the rotation of the locking servomotor 47.

The second detector 51 sends the detected information to the controller 18. “Information about the locking state” is not limited to the directly measured locking force and the like and may be information about the about the position of the movable platen 13 or the locking drive mechanism 17, the speed of the movable platen 13 or the locking drive mechanism 17, the acceleration of the movable platen 13 or the locking drive mechanism 17, or torque of the locking drive mechanism 17 that can be determined by the controller 18 by mathematical calculation based on the information.

The second detector 51 is not limited to the one provided in the locking servomotor 47 and may be one provided in other portions such as the movable platen 13 or the locking drive mechanism 17. The second detector 51 may also be other than the one described above.

As shown in FIG. 1, the injection apparatus 3 is provided behind the stationary platen 12. The injection apparatus 3 includes a heating barrel 61, a screw 62, a measuring unit 63, and an injection apparatus drive unit 64. The injection apparatus 3 injects a molten material into a die.

As shown in FIG. 1, the injection molding machine 1 is provided with a man-machine interface (hereinafter, referred to as an MMI/F) 71. The MMI/F 71 is also called a human-machine interface (HMI). An operator can input settings such as instructions about the operation of the injection molding machine 1 through the MMI/F 71. Examples of information that can be input through the MMI/F 71 include a threshold used for an error detection operation described later.

The controller 18 is in charge of, for example, overall control of the injection molding machine 1. The controller 18 according to the present embodiment performs an error detection operation based on information sent from the first detector 31. A portion of the controller 18 collaborates with the first detector 31 to constitute an example of an error detection unit 81. The error detection operation of the controller 18 will be described in detail below.

The controller 18 is controlling the protruding drive mechanism 16 and the locking drive mechanism 17 to push out the ejecting member 15 before or during a closing operation. Next, the controller 18 performs the closing operation in a pushed-out state of the ejecting member 15 and monitors information about the state of the ejecting member 15 or the protruding drive mechanism 16 received from the first detector 31. Then, when the ejecting member 15 comes into contact with, for example, a molded product remaining in the die or extraneous material such as a burr, the controller 18 detects such matter as extraneous material based on a state change of the ejecting member 15 or the protruding drive mechanism 16. That is, the controller 18 monitors information received from the first detector 31 and detects the presence of extraneous material when a numeric value obtained from the information, that is, a numeric value contained in the information or calculated based on a numeric value contained in the information exceeds a preset threshold.

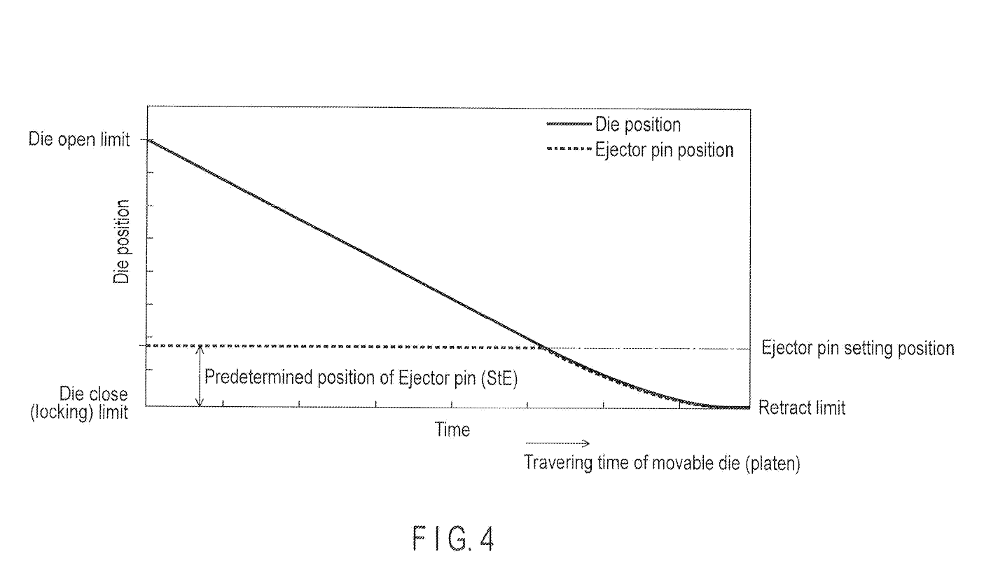

More specifically, as shown in FIG. 4, an example of the controller 18 drives the protruding drive mechanism 16 before the closing operation to push out the ejecting member 15 by any predetermined amount (predetermined length) StE. That is, after the ejecting member 15 being pushed out by the predetermined amount StE, the movable platen 13 is moved toward the stationary platen 12 to perform the closing operation.

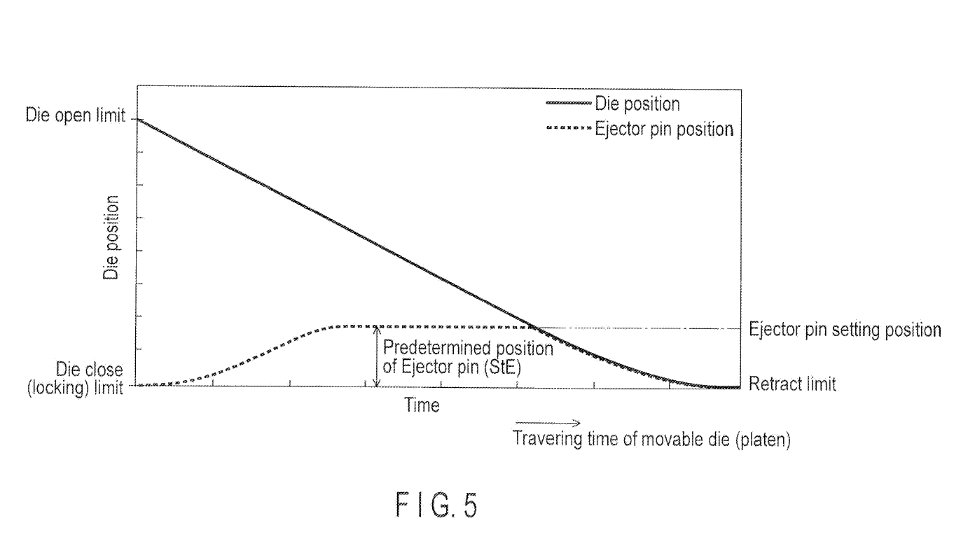

Instead, as shown in FIG. 5, the controller 18 may drive the protruding drive mechanism 16 during the closing operation to push out the ejecting member 15 by any predetermined amount StE. That is, the controller 18 may perform the closing operation by extruding the ejecting member 15 up to the predetermined amount StE by some position during the closing operation.

As shown in FIGS. 4 and 5, the ejecting member 15 is put on standby while being protruded during the closing operation and caused to rest with respect to the movable platen 13. As shown in FIG. 2, while the ejecting member 15 is on standby, the torque of the push-out servomotor 27 is constant at zero. The controller 18 monitors for a state change of the ejecting member 15 or the protruding drive mechanism 16 while the ejecting member 15 is maintained at rest with respect to the movable platen 13.

The controller 18 presets a detection pressing force as a threshold of torque variations of the push-out servomotor 27. The threshold is set by, for example, a preset internal parameter or a value input by an operator through the MMI/F 71.

The controller 18 monitors variations of torque of the push-out servomotor 27 obtained from information of the first detector 31. If no variation of torque of the push-out servomotor 27 is detected, the controller 18 determines that there is no extraneous material in contact with the ejecting member 15 and the closing operation is normal.

If extraneous material remains between the stationary die 21 and the movable die 22 due to an ejection error or drop error, the extraneous material first comes into contact with the ejecting member 15. The torque of the push-out servomotor 27 changes when the ejecting member 15 comes into contact with extraneous material. The controller 18 determines that the ejecting member 15 has come into contact with extraneous material and detects the extraneous material when the torque of the push-out servomotor 27 varies by exceeding a threshold. That is, the controller 18 sets a torque limit on the threshold and when the torque of the push-opt servomotor 27 reaches the torque limit, the controller 18 performs extraneous material detection processing.

In the above example, the controller 18 monitors the torque of the push-out servomotor 27, that is, the torque of the protruding drive mechanism 16, but instead or in addition thereto, one or a plurality of the position of the ejecting member 15, the position of the protruding drive mechanism 16, the speed of the protruding drive mechanism 16, and acceleration of the protruding drive mechanism 16 may be monitored. While the ejecting member 15 is at rest with respect to the movable platen 13, the change of the relative position of the ejecting member 15 with respect to the movable platen 13, the speed of the ejecting member 15, and the acceleration of the ejecting member 15 are constant at zero.

With the closing operation advancing, as shown in FIGS. 4 and 5, the controller 18 retreats, that is, moves the ejecting member 15 to the left in FIG. 1. A retreating operation of the ejecting member 15 with respect to the movable platen 13 relates to the interval between the stationary die 21 and the movable die 22 and is controlled so that the ejecting member 15 does not come into contact with the stationary die 21.

More specifically, the interval between the stationary die 21 and the movable die 22 is calculated based on the position of the ejecting member 15 and the amount of movement of movable platen 13. The controller 18 completes the closing operation by bringing in the ejecting member 15 so that the ejecting member 15 does not come into contact with the stationary die 21 by fitting to the operation in which the movable platen 13 moves toward the stationary platen 12 after halfway through the closing operation. That is, as the closing operation advances, the controller 18 exercises control so that the ejecting member 15 does not come into contact with the stationary die 21 by retreating the ejecting member 15.

In other words, a changing pattern of the die position can be calculated in advance based on, for example, the operation of the locking servomotor 47 and the configuration of the toggle mechanism. The controller 18 retreats the ejecting member 15 so as to match the changing pattern. That is, when the closing operation advances and the die position reaches the protrusion amount StE of the ejecting member 15, the controller 18 starts the retreating operation of the ejecting member 15. Then, when the movable die 22 touches the stationary die 21, the ejecting member 15 is brought in to such a position that the tip of the ejecting member 15 does not protrude from the movable die 22. The “die position” is the interval between the stationary die 21 and the movable die 22.

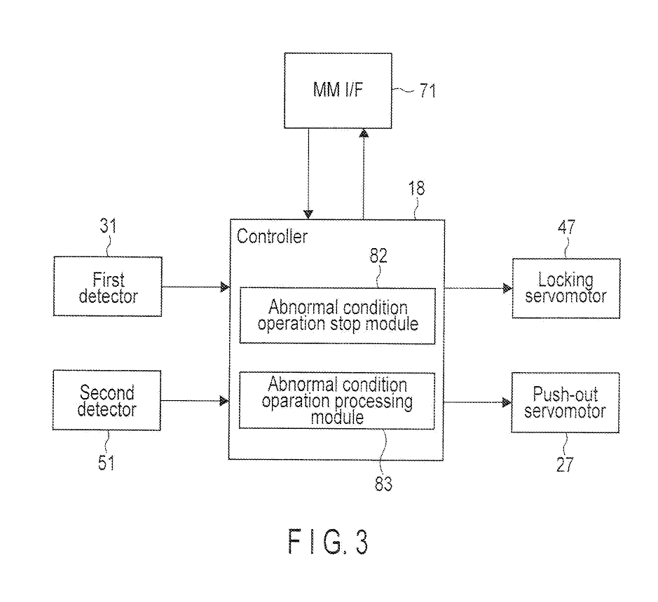

As shown schematically in FIG. 3, the controller 18 includes an abnormal condition operation stop module 82 and an abnormal condition operation processing module 83. The abnormal condition operation stop module 82 is an example of an “abnormal condition operation stop unit”. When extraneous material is detected, the abnormal condition operation stop module 82 stops the operation of the locking drive mechanism 17.

The abnormal condition operation processing module 83 is an example of an “abnormal condition operation processing unit”. The abnormal condition operation processing module 83 retreats the ejecting member 15, when extraneous material is detected. The abnormal condition operation processing module 83 retreats the ejecting member 15 to the position in which the tip of the ejecting member 15 does not protrude from the movable die 22, for example, a retreat limiting point.

The abnormal condition operation stop module 82 and the abnormal condition operation processing module 83 may each be realized by hardware, but may also be realized by software as a portion of the control program.

Next, a modification of the controller 18 will be described.

Another example of the controller 18 records and stores information about the state of the ejecting member 15 or the protruding drive mechanism 16 when a closing operation is performed excellently. The controller 18 stores information when a closing operation is performed excellently, for example, the changing pattern of the position of the ejecting member 15, the position of the protruding drive mechanism 16, the speed of the protruding drive mechanism 16, the acceleration of the protruding drive mechanism 16, or the torque of the protruding drive mechanism 16.

The controller 18 compares a numeric value about the state of the ejecting member 15 or the protruding drive mechanism 16 obtained from information of the first detector 31, a measured value in this case, with the changing pattern stored in the controller 18 when a closing operation is performed excellently. When the numeric value obtained from information of the first detector 31 varies by exceeding a threshold preset for the stored changing pattern, the controller 18 determines that the ejecting member 15 has come into contact with extraneous material and detects the extraneous material.

More specifically, for example, the controller 18 calculates a difference between a speed pattern calculated in advance and the actual speed and performs error detection processing when the difference grows to a predetermined amount or more. Instead, the controller 18 may also perform error detection processing based on a difference between a position pattern calculated in advance and the actual position, a difference between an acceleration pattern calculated in advance and the actual acceleration, or a difference between a torque pattern during normal operation and the actual torque. These detection methods may be used alone or in combination.

According to the above configuration, the precision with which an error is detected can be improved.

For purposes of comparison, a molding machine that detects an error by monitoring torque of the locking servomotor 47 that moves the movable platen 13 and compares the detected value with a value during normal operation will be considered. In this case, an impact when a sandwiched molded product comes into contact with the die or a change of torque generated in a motor when the movable platen moved by the motor crushes a molded product is detected.

The die 22 and the movable platen 13 are heavy and the torque needed to move the movable platen 13 correspondingly becomes large. A molded product is light and soft when compared with the die 22 and the movable platen 13. Therefore, the impact when a molded product comes into contact with the die and the change of torque generated in a motor when the movable platen moved by the motor crushes a molded product are very small as an amount of change. Hence, the molded product may already be terribly crushed with damaging the die, when the amount of change of the torque generated in the motor comes out clearly by comparing a current detection result with a result which is detected during normal operation.

The torque of the locking servomotor 47 varies to some extent depending on a greasing state of the injection apparatus 3. Further, the locking servomotor 47 is a motor that performs a closing operation and is driven during the closing operation. That is, as shown in FIG. 2, the locking servomotor 47 causes large torque variations containing acceleration torque and deceleration torque causing the movable platen 13 to move during closing operation. Such torque of the motor while being driven is likely to vary greatly by being affected by sliding resistance of the guide and other disturbance factors. Therefore, the threshold used to determine whether an error occurs by comparing with a value during normal operation becomes a value with a margin that takes variations into consideration. Also from this point, when the amount of change of torque of the motor becomes clear, the molded product may already be crushed to a large extent, damaging the die.

The injection molding machine 1 according to the present embodiment includes an error detection unit 81 that detects extraneous material based on a state change of the ejecting member 15 or the protruding drive mechanism 16 after a closing operation being started while the ejecting member 15 is protruded.

When compared with the movable platen 13 and the like, the ejecting member 15 has a lighter weight of a movable portion, that is, smaller inertia. That is, the torque of the push-out servomotor 27 to drive the ejecting member 15 is smaller than the torque of the locking servomotor 47. Thus, an impact when the ejecting member 15 comes into contact with a molded product during closing operation is more likely to appear clearly as a change of torque of the motor. It is possible to make the precision for detecting an error improve, because the extraneous material can be detected before the extraneous material being terribly crushed.

Further, in the present embodiment, the ejecting member 15 is put on standby while being protruded during the closing operation and caused to rest with respect to the movable platen 13. The torque of the push-out servomotor 27 in this case is, as shown in FIG. 2, basically constant at zero. Such torque of the motor on standby is less likely to vary and so a smaller threshold can be set. Thus, an error can be detected based on the change, even if the torque of the push-out servomotor 27 changes only slightly. Hence, the detection precision of extraneous material is further improved.

Also in the present embodiment, the die is less likely to be damaged because a die protective function in which the ejecting member 15 comes into contact with extraneous material prior to the die is actuated. That is, there is a possibility that the locking process can be stopped after only the ejecting member 15 being damaged. That is, only the ejecting member 15, for example, the ejector pin 26 that is less expensive than the die needs to be replaced. As a result, maintenance costs can be reduced.

The ejecting member 15 is a member used to eject a molded product and is included in many existing molding machines. According to the present embodiment, the ejecting member 15 that is not used normally for closing operation is utilized to improve the precision of error detection without providing any other special additional member. That is, the injection molding machine 1 in the present embodiment can be achieved by replacing the control program in existing molding machines without entailing high cost.

Also in the present embodiment, the ejecting member 15 is prevented from being damaged by the ejecting member 15 being brought in up to the retreat limit when extraneous material is detected.

In addition to the above content, the controller 18 in the present embodiment may complement an error detection operation based on, for example, information sent from the second detector 51. That is, the controller 18 monitors information about the locking state received from the second detector 51. Then, when extraneous material is sandwiched between the stationary die 21 and the movable die 22, the controller 18 detects the extraneous material from a change of the locking state.

That is, the controller 18 sets the threshold to variations of each of, for example, the position of the movable platen 13 or the locking drive mechanism 17, the speed of the movable platen 13 or the locking drive mechanism 17, the acceleration of the movable platen 13 or the locking drive mechanism 17, or the torque of the locking drive mechanism 17, etc., and detects the extraneous material when variations thereof exceed the respective thresholds. According to such a configuration, the presence of the remaining molded product can be detected, even if a molded product remains in a position where the ejecting member 15 does not come into contact.

In the foregoing, an embodiment of the present invention has been described, but the embodiment of the present invention is not limited to the above descriptions. Moreover, the present invention may be applied not only to whole operation of a closeing operation as all processes of the closing operation, but also to a partial section during the closing operation, that is, only a portion of the closing operation. For example, the die protection may be enabled for only a portion of a closing stroke. The present invention can be embodiment by modifying structural elements without deviating from the scope and spirit thereof in a working stage. The present invention can be applied to other molding machines such as a die casting machine, transfer molding machine, and pressing machine, as well as the injection molding machine.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A locking apparatus, comprising:
a stationary platen on which a stationary die is mounted;
a movable platen on which a movable die is mounted;
a locking drive mechanism that advances or retreats the movable platen;
an ejecting member held in the movable platen to remove a molded product from the movable die;
a protruding drive mechanism that pushes out the ejecting member from the movable die; and
an error detection unit that detects extraneous material based on a state change of the ejecting member or the protruding drive mechanism at least during a closing operation.

2. The locking apparatus of claim 1, wherein
the ejecting member is protruded from the movable die before or during the closing operation;
the locking drive mechanism performs the closing operation in a protruded state or a protruding state of the ejecting member; and
the error detection unit detects that the ejecting member has come into contact with the extraneous material based on the state change of the ejecting member or the protruding drive mechanism.

3. The locking apparatus of claim 1, wherein
the ejecting member is caused to rest with respect to the movable platen in a protruded state during the closing operation; and
the error detection unit monitors for the state change of the ejecting member or the protruding drive mechanism while the ejecting member is maintained at rest with respect to the movable platen.

4. The locking apparatus of claim 1, wherein
the error detection unit detects that the ejecting member has come into contact with the extraneous material based on changes of at least one of a position of the ejecting member, a position of the protruding drive mechanism, a speed of the protruding drive mechanism, an acceleration of the protruding drive mechanism, and a torque of the protruding drive mechanism.

5. The locking apparatus of claim 1, wherein
the error detection unit registers a changing pattern which includes at least one of a position of the ejecting member, a position of the protruding drive mechanism, a speed of the protruding drive mechanism, an acceleration of the protruding drive mechanism, and torque of the protruding drive mechanism when the closing operation is performed excellently; and detects that the ejecting member has come into contact with the extraneous material by comparing at least one of a detected position of the ejecting member, a detected position of the protruding drive mechanism, a detected speed of the protruding drive mechanism, a detected acceleration of the protruding drive mechanism, and a detected torque of the protruding drive mechanism with the corresponding changing pattern.

6. A control method for a locking apparatus which includes,
a stationary platen on which a stationary die is mounted;
a movable platen on which a movable die is mounted;
a locking drive mechanism that advances or retreats the movable platen;
an ejecting member held in the movable platen to remove a molded product from the movable die; and
a protruding drive mechanism that pushes out the ejecting member from the movable die,
the control method comprising:
detecting extraneous material based on a state change of the ejecting member or the protruding drive mechanism at least during a closing operation.

7. The control method of claim 6, further comprising:
protruding the ejecting member before or during the closing operation;
performing the closing operation in a protruded state or a protruding state of the ejecting member; and
detecting that the ejecting member has come into contact with the extraneous material based on the state change of the ejecting member or the protruding drive mechanism.

8. The control method of claim 6, further comprising:
causing the ejecting member to rest with respect to the movable platen in a protruded state during the closing operation; and
monitoring for the state change of the ejecting member or the protruding drive mechanism while the ejecting member is maintained at rest with respect to the movable platen.

9. The control method of claim 6, further comprising:
detecting that the ejecting member has come into contact with the extraneous material based on changes of at least one of a position of the ejecting member, a position of the protruding drive mechanism, a speed of the protruding drive mechanism, an acceleration of the protruding drive mechanism, and a torque of the protruding drive mechanism.

10. The control method of claim 6, further comprising:
registering at least one changing pattern of a position of the ejecting member, a position of the protruding drive mechanism, a speed of the protruding drive mechanism, an acceleration of the protruding drive mechanism, and a torque of the protruding drive mechanism when the closing operation is performed excellently;
detecting actually at least one changing pattern of the position of the ejecting member, the position of the protruding drive mechanism, the speed of the protruding drive mechanism, the acceleration of the protruding drive mechanism, and the torque of the protruding drive mechanism; and
detecting that the ejecting member has come into contact with the extraneous material by comparing the detected changing pattern with the registered corresponding changing pattern.
